(19) United States
(12) Patent Application Publication
(10) Pub. No.: US 2012/0227826 A1
(43) Pub. Date: Sep. 13, 2012

(54) DRAINAGE SYSTEM FOR USE IN BASEMENTS AND A METHOD FOR ITS INSTALLATION AND USE

(76) Inventors: Robert Luke Secrest, Reynoldsburg, OH (US); Dan E. Reed, Aurora, OH (US)

(21) Appl. No.: 13/041,953

(22) Filed: Mar. 7, 2011

(51) Int. Cl. F16L 5/00

(52) U.S. Cl. 137/15.01; 137/362

(57) ABSTRACT

A basement drainage system and method for its use comprising a combination of floor drains and poly drains, wherein each can transport water to one or more sump basins to be pumped out of a basement and away from a building. This basement drainage system can effectively remove ground water located below a basement floor as well as water that collect on the surface of the basement floor.

### FIELD OF THE INVENTION

The present basement drainage system is an improvement upon existing systems used to protect buildings from water infiltration. A sump basin containing a sump pump is typically installed in buildings having basements. Cracks and the porous nature of basement walls and foundations often allow water to enter into basements of buildings, which can lead to the growth of mold, or damage these structures. Additionally, ground water can infiltrate basements from below when water tables rise. A drainage system comprising multiple drains, in addition to at least one sump basin and sump pump, can provide adequate capacity to remove both types of infiltrating water and meet the criteria set forth by the BOCA, SBCCI and ICBO National Building Codes.

### BACKGROUND

Foundations and basement walls support the weight of the entire upper portion of a building and are typically made from poured concrete or cinderblocks. These materials can often allow water to penetrate through them because they are either porous or contain cracks. Hydrostatic pressure outside of a building's basement can cause water to push through these pores, cracks and other small spaces in basement and foundation walls as well as basement floors. This water, once it has penetrated into the basement, can lead to the growth of mold, musty odors and can even damage the foundation by expanding and eroding existing cracks.

The current system, which is widely used and approved by the National Building Code provides for a sump basin to collect water from the surface of the basement floor. The sump basin contains a sump pump to remove water from the basement and move it away from the building. In addition to the collection of water from the basement floor, this system contains a poly drain beneath the floor to collect any water in the ground under the building, relieving water pressure asserted against the floor.

This system has proven effective for removing water in the ground. However, the use of a sump basin alone to remove moisture from the basement floor surface is not particularly efficient or effective. This can create wet basement floors for prolonged periods, which can lead to unsafe conditions and the growth of harmful organisms. Additionally, liquid on the inside of the floor can ruin any finishing materials, such as carpeting, wall board, and wood trim, that have been installed in the basement.

What is needed is a system which can both prevent ground water from seeping up and into the basement as well as efficiently and effectively remove water from the surface of the basement floor.

### SUMMARY OF THE INVENTION

It is an aspect of the present basement drainage system to both prevent ground water from seeping into the basement from below and remove water from the surface of the basement floor and meets the standards set forth by the National Building Code.

The above aspect can be obtained by a basement drainage system, comprising at least one sump basin, at least one sump pump, at least one poly drain capable of transporting water to the sump basin, and at least one floor drain along the perimeter of a basement wall capable of transporting water to the sump basin.

The above aspect can also be obtained by a basement drainage system, comprising, at least one sump basin, at least one sump pump, at least one poly drain capable of transporting water to the sump basin, a first floor drain located along the inner perimeter of a basement wall capable of transporting water to the sump basin, and a second floor drain located along the inner perimeter of the first floor drain capable of transporting water to the sump basin.

The above aspect can also be obtained by a method for installing and using a basement drainage system, the method comprising. providing a basement drainage system having at least one sump basin, at least one sump pump, at least one poly drain capable of transporting water to the sump basin, a first floor drain located along the inner perimeter of a basement wall capable of transporting water to the sump basin, and a second floor drain located along the inner perimeter of the first floor drain capable of transporting water to the sump basin, and placing at least one sump basin in a basement floor, wherein the sump basin is located below the surface of a the basement floor, placing at least one sump pump into at least one sump basin, wherein the sump pump can transport water from the sump basin out of the basement, placing at least one poly drain capable of transporting water to at least one sump basin below the basement floor, wherein one or more poly drains can transport ground water located below the basement floor to one or more sump basins, where it can be pumped out of the basement by one or more sump pumps, placing a first floor drain located along the inner perimeter of a basement wall capable of transporting water to at least one sump basin, this first floor drain being capable of collecting water located on the surface of the basement floor, and placing a second floor drain located along the inner perimeter of the first floor drain capable of transporting water to at least one sump basin, this second floor drain being capable of collecting water located on the surface of the basement floor.

These together with other aspects and advantages, which will be subsequently apparent, reside in the details of construction and operation as more fully hereinafter described and claimed, reference being had to the accompanying drawings forming a part thereof, wherein like numerals refer to like parts throughout.

### BRIEF DESCRIPTION OF THE DRAWINGS

Further features and advantages of the present device, as well as the structure and operation of various embodiments of the present device, will become apparent and more readily appreciated from the following description of the preferred embodiments, taken in conjunction with the accompanying drawings of which:

FIG. 1 is a cut-away view of a standard basement drainage system known to exist in the prior art;

FIG. 2 is a cut-away view of a basement drainage system comprising floor drains, but no poly drain known to exist in the prior art;

FIG. 3 is a cut-away view of a basement drainage system comprising a floor drain and a poly drain, according to an embodiment;

FIG. 4 is a cut-away view of a basement drainage system comprising an outer floor drain, an inner floor drain and a poly drain, according to an embodiment.

FIG. 5 is a top plan view of a basement drainage system comprising an outer floor drain, and inner floor drain and a poly drain, according to an embodiment;

FIG. 6 is a top plan view of a basement drainage system comprising an outer floor drain, an inner floor drain and a poly drain, wherein the foundation is depicted by broken lines, according to an embodiment; and

FIG. 7 is a top plan view of a basement drainage system, wherein the poly drain and the foundation are each depicted by broken lines, according to an embodiment.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

Reference will now be made in detail to the presently preferred embodiments of the invention, examples of which are illustrated in the accompanying drawings, wherein like reference numerals refer to like elements throughout.

A system for both preventing water from accumulating on the surface of a basement floor as well as preventing ground water from infiltrating the basement from below has been developed. The purpose of this system is to create a basement drainage system that is efficient and effective enough to prevent water infiltrating a basement from reaching the basement floor's surface except for at its edges. This system also comprises at least one poly drain sufficient to prevent ground water from infiltrating the basement from below floor. This basement drainage system complies with the standards set forth under the National Building Codes.

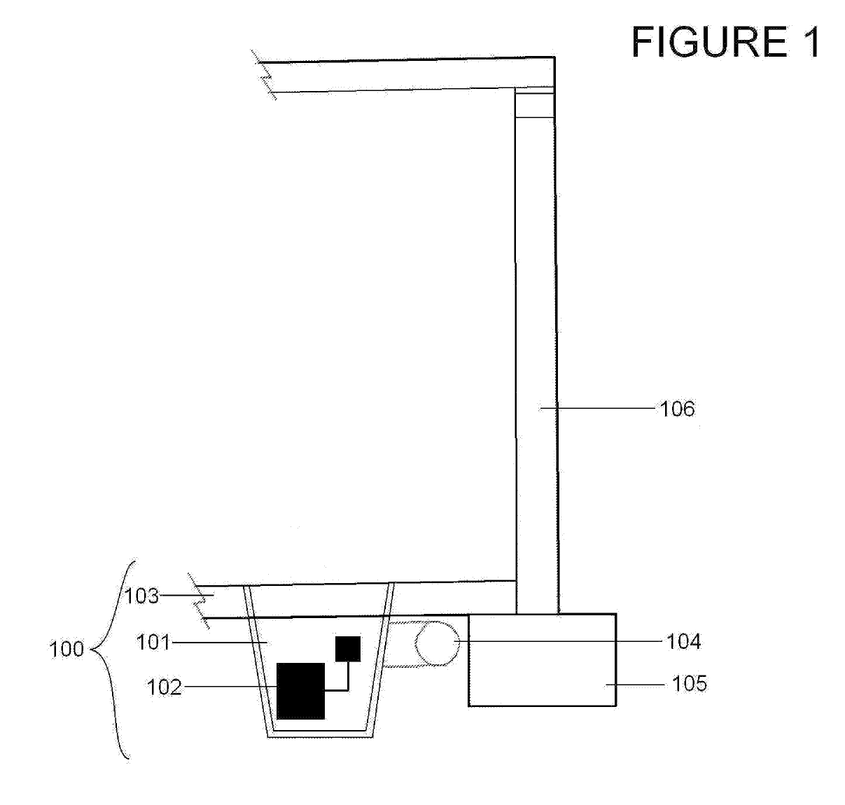

FIG. 1 is a cut-away view of a standard basement drainage system 100 known to exist in the prior art.

A standard basement drainage system 100 typically comprises a sump basin 101 and a sump pump 102. A sump basin 101 is typically a roughly cylindrical hole having a bottom two to three feet below the surface of a basement floor 103. The basement floor 103 is usually graded so that water can flow from anywhere on the floor 103 toward and into the sump basin 101. Water collected in the sump basin 101 is then transported out of the basin 101 and away from the home by a sump pump 102 located in the sump basin 101. Tubing (not pictured) is commonly attached to a sump pump 102, which directs the water from the pump 102 outside the basement and away from the building.

This standard basement drainage system 100 also removes ground water from below the basement floor 103. In such systems, ground water is collected in permeable, flexible tubing, commonly referred to as “poly drains” 104. Poly drains 104 are typically located below the basement floor 103 and inside the foundation 105. The poly drains 104 are positioned so that ground water can be pushed by gravity to flow through the poly drain 104 to the sump basin 101 to be removed by the sump pump 102.

The standard basement drainage system 100 has proven effective for removing both ground water and large quantities of water from the surface of basement floors 103 and has been National Build Code approved. However, many modern buildings have finished basements, which comprise building materials and furnishings, which can be damaged or ruined if contacted by water. Therefore, it is more important than ever to remove water from basement floors as quickly as possible. Standard basement drainage systems 100, such as that depicted in FIG. 1, allow water to flow on the surface of the basement floor 103 until it reaches the sump basin 101 or evaporates. Such systems allow water to contact building materials and furnishings, which can cause substantial damage each time water is able to penetrate the basement's walls 105.

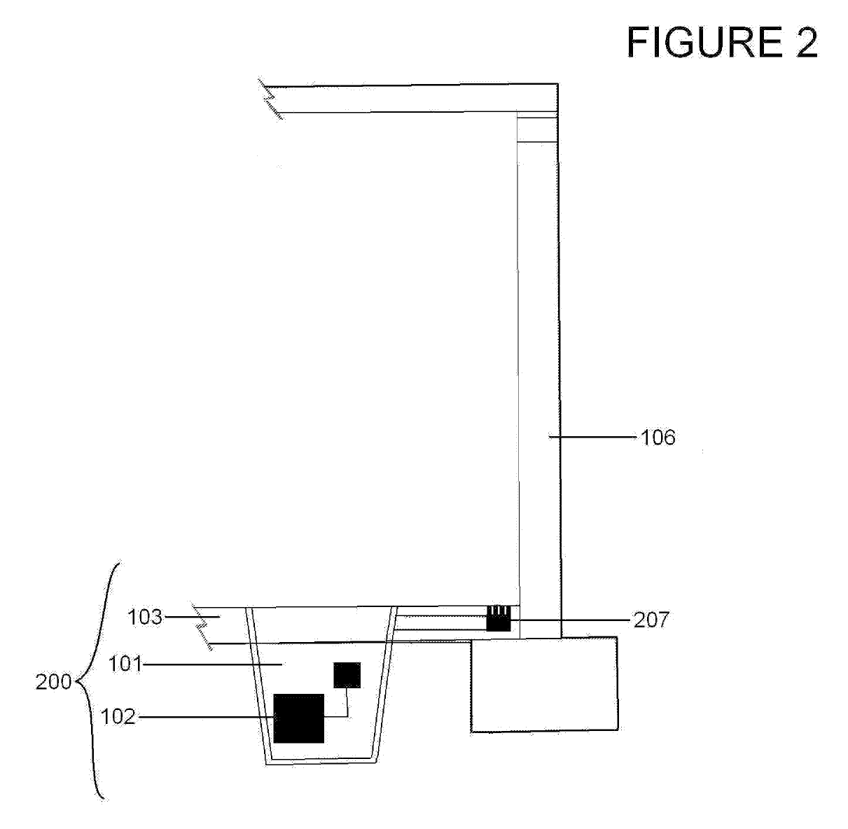

FIG. 2 is a cut-away view of an unapproved basement drainage system 200 comprising a floor drain 207, but no poly drain, which is known to exist in the prior art.

The unapproved basement drainage system 200 depicted in FIG. 2 is designed to remove water from the surface of a basement floor 103 quickly after it has penetrated the basement walls 105. By placing a floor drain 207 all along the bottom of the basement wall 105, water is collected before it can reach most of the carpets, furnishings and similar material located in the middle of the basement, inside the perimeter created by the floor drain 207. The floor drain 207 can be roughly at the same level as, or slightly below the level of the top of the basement floor 103. Gravitational forces can be used to move water captured by the floor drain 207 to the sump basin 101 where it can be pumped out of the basement. However, the unapproved basement drainage system 200 has not been National Build Code approved because it does not prevent ground water from reaching the basement floor 203 from below.

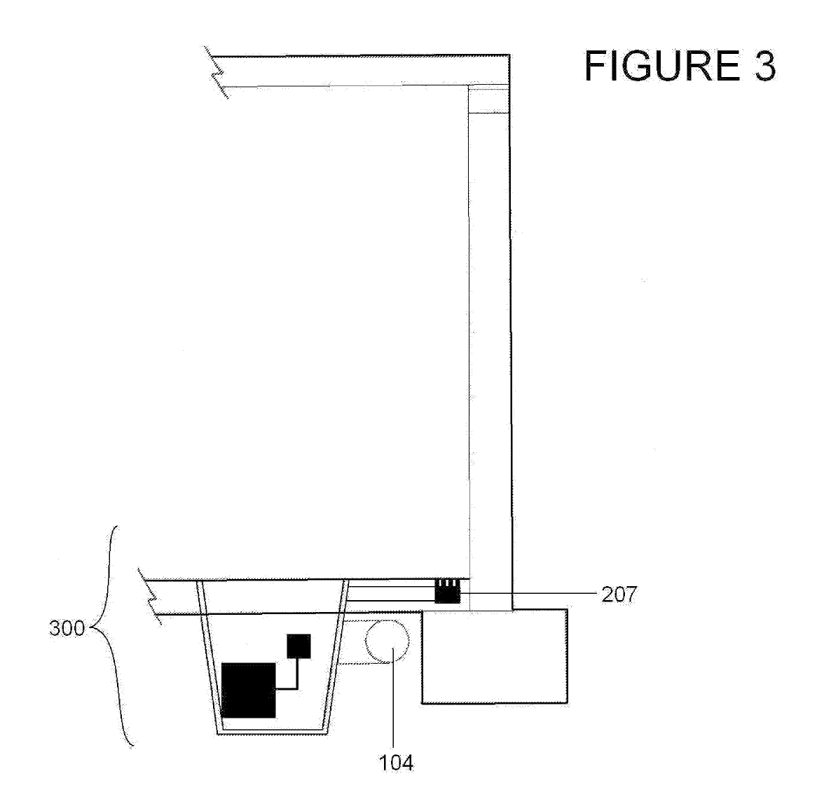

FIG. 3 is a cut-away view of a present basement drainage system 300 comprising a floor drain 207 and a poly drain 104, according to an embodiment.

The present basement drainage system 300 combines the features of the drainage systems depicted in FIGS. 1 and 2. The present basement drainage system 300 comprises a poly drain 104 for preventing the infiltration of ground water as found in the standard basement drainage system 100. It also comprises a floor drain 207 along the basement walls as found in the unapproved basement drainage system 200.

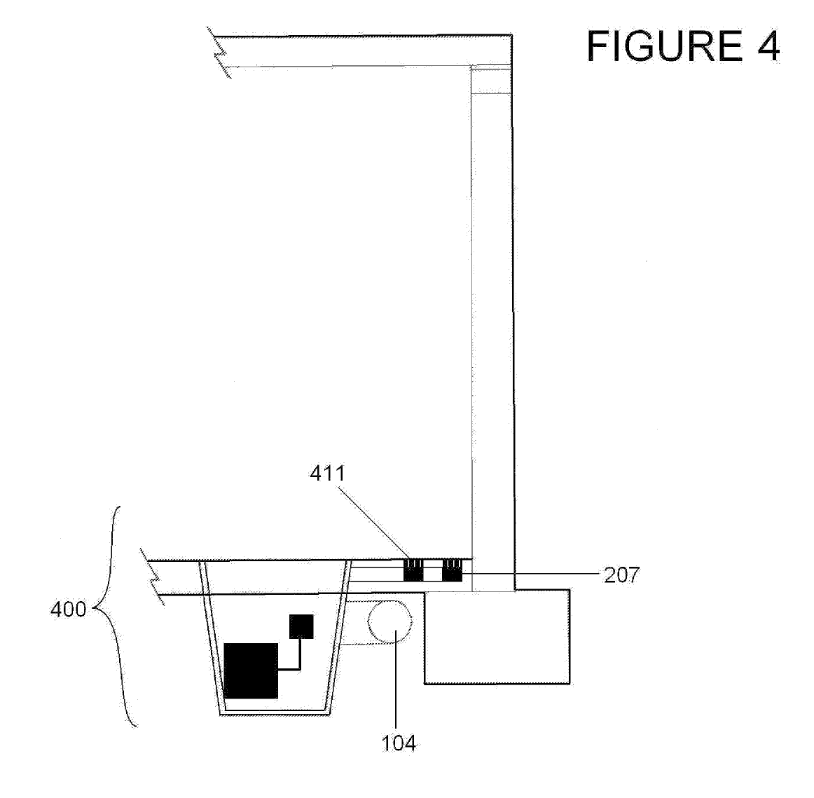

FIG. 4 is a cut-away view of a present basement drainage system 400 comprising an outer floor drain 207, an inner floor drain 411 and a poly drain 104, according to an embodiment.

In this alternative embodiment, two floor drains can be placed along the basement walls comprising the basement. An outer floor drain 207 can be place in roughly the same position as used in the single floor drain embodiment and an inner floor drain 411 can be placed inside outer floor drain 207. Both floor drains can carry water to the sump basin, where it can be pumped out of the basement.

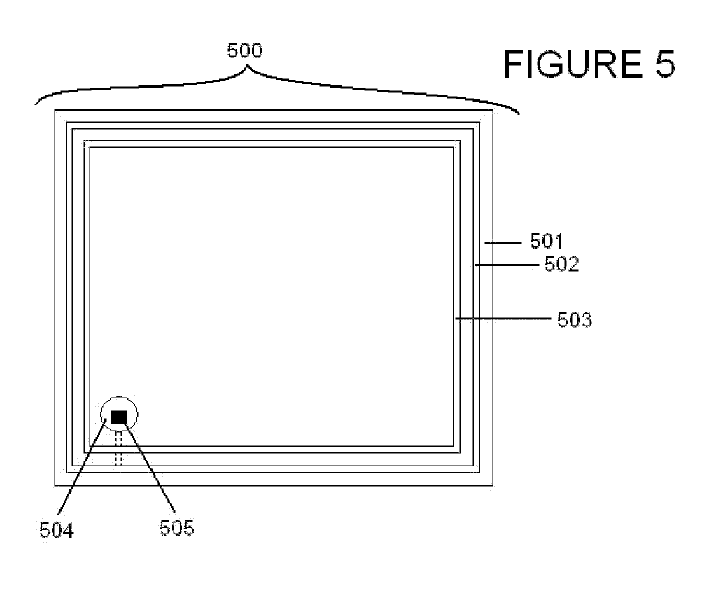

FIG. 5 is a top plan view of a present basement drainage system 500 comprising an outer floor drain 502, an inner floor drain 503 and a poly drain (not pictured), according to an embodiment.

In this alternative embodiment, the present basement drainage system 500 comprises an outer floor drain 502, which is located along the entire base of a basement wall 501. An inner floor drain 503 can be located along the inner perimeter of the outer floor drain 402. Both the outer floor drain 502 and the inner floor drain 503 can allow for the transportation of water to a sump basin 504 via gravity where it can be pumped out of the basement through the use of a sump pump 505.

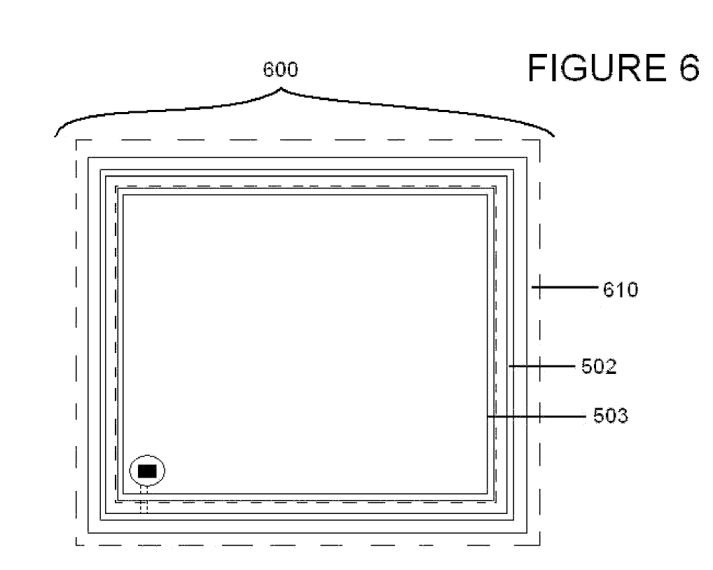

FIG. 6 is a top plan view of a present basement drainage system 600 comprising an outer floor drain 502, an inner floor drain 503 and a poly drain (not pictured), wherein a foundation 610 is depicted by broken lines, according to an embodiment.

In a preferred embodiment, the present basement drainage system 600 can comprise can an outer floor drain 502 is located over the foundation, between the base of the inside of the basement wall and the edge of the inside of the foundation 610. The inner floor drain 503 can be located inside of the inside edge of the foundation 610 so that it is not over the foundation 610.

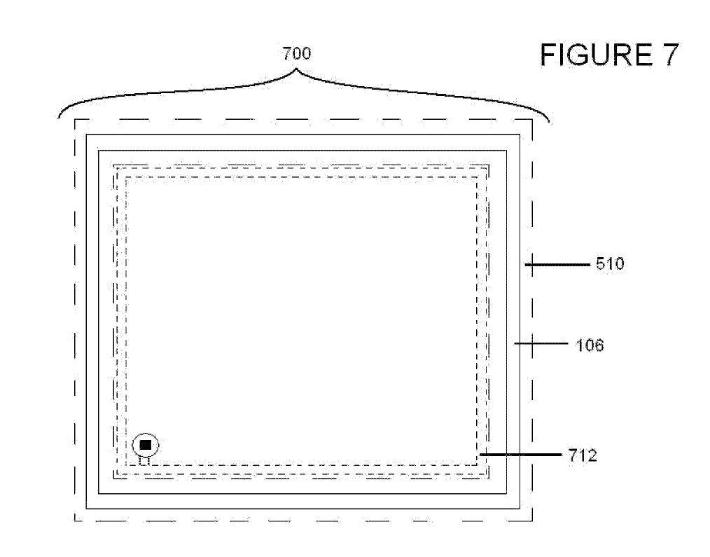

FIG. 7 is a top plan view of a present basement drainage system 700 comprising an outer floor drain (not pictured), an inner floor drain (not pictured) and a poly drain, according to an embodiment.

In a preferred embodiment the poly drain 712 can be placed along the inside edge of the foundation 510 below the basement floor thus forming a perimeter approximately one foot within the perimeter formed by the basement walls 106. As do the floor drains (not pictured), the poly drain uses gravity to transport water to the sump basin. Poly drains are typically perforated drain hoses made from a polymer.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A basement drainage system, comprising:
a basement having walls at its perimeter and a basement floor located in the area within the walls;
at least one sump basin placed partially below the basement floor;
at least one sump pump placed within the sump basin;
at least one poly drain placed below the basement floor which is constructed to drain water to the sump basin using gravity; and
at least one floor drain placed along the perimeter of the walls constructed to drain water to the sump basin using gravity.

2. The basement drainage system as recited in claim 1, wherein at least one sump pump is located within at least one sump basin.

3. The basement drainage system as recited in claim 1, wherein the poly drain is a perforated drain hose made from a polymer.

4. The basement drainage system as recited in claim 1, wherein the top of the floor drain is level with the top of a basement floor.

5. A basement drainage system, comprising:
a basement having walls at its perimeter and a basement floor located in the area within the walls;
at least one sump basin placed partially below the basement floor;
at least one sump pump placed within the sump basin;
at least one poly drain placed below the basement floor which is constructed to drain water to the sump basin using gravity ; and
an inner floor drain located along the inner perimeter of the basement wall constructed to drain water to the sump basin using gravity; and
an outer floor drain located along the inner perimeter of the inner floor drain constructed to drain water to the sump basin using gravity

6. The basement drainage system as recited in claim 5, wherein at least one sump pump is located within at least one sump basin.

7. The basement drainage system as recited in claim 5, wherein the poly drain is a perforated drain hose made from a polymer.

8. The basement drainage system as recited in claim 5, wherein the tops of both the inner and outer floor drains are level with the top of a basement floor.

9. A method for installing and using a basement drainage system, the method comprising:
providing a basement having walls at its perimeter and a basement floor located in the area within the walls, a basement drainage system having at least one sump basin, at least one sump pump, at least one poly drain constructed to drain water to the sump basin using gravity, an outer floor drain located along the inner perimeter of a basement wall constructed to drain water to the sump basin using gravity, and an inner floor drain located along the inner perimeter of the outer floor drain constructed to drain water to the sump basin using gravity; and
placing at least one sump basin in a basement floor, wherein the sump basin is located partially below the surface of a the basement floor;
placing at least one sump pump into at least one sump basin, wherein the sump pump can transport water from the sump basin out of the basement;
placing at least one poly drain constructed to drain water to at least sump basin using gravity , wherein one or more poly drains constructed to drain ground water located below the basement floor to one or more sump basins using gravity, where it can be pumped out of placing an outer floor drain along the inner perimeter of a basement wall constructed to drain water to at least one sump basin, this outer floor drain being capable of collecting water located on the surface of the basement floor; and
placing an inner floor drain located along the inner perimeter of the outer floor drain constructed to drain water to at least one sump basin, this inner floor drain being capable of collecting water located on the surface of the basement floor.

10. The method as recited in claim 9, wherein at least one sump pump is located within at least one sump basin.

11. The method as recited in claim 9, wherein the poly drain is a perforated drain hose made from a polymer.

12. The method as recited in claim 9, wherein the top of the inner floor drain is level with the top of a basement floor.

13. The method as recited in claim 9, wherein the top of the outer floor drain is level with the top of a basement floor.

14. The method as recited in claim 9, wherein the inner floor drain is located above a foundation.

15. The method as recited in claim 9, wherein the outer floor drain is not located above a foundation.
